(19) United States
(12) Patent Application Publication
(10) Pub. No.: US 2026/0291842 A1
(43) Pub. Date: Sep. 24, 2026

(54) NETWORK RESOURCE MONITORING

(71) Applicant: Intel Corporation, Santa Clara, CA (US)

(72) Inventors: Junggun LEE, Los Altos, CA (US); Grzegorz JERECZEK, Gdansk (PL); Junho SUH, Pleasanton, CA (US); Anil VASUDEVAN, Portland, OR (US)

(73) Assignee: Intel Corporation, Santa Clara, CA (US)

(21) Appl. No.: 19/677,666

(22) Filed: May 14, 2026

Related U.S. Application Data
(63) Continuation of application No. 17/667,415, filed on Feb. 8, 2022.
Application No. 17/667,415 is a continuation-in-part of application No. 17/482,822, filed on Sep. 23, 2021, now Pat. No. 12,301,476.
(60) Provisional application No. 63/130,667, filed on Dec. 26, 2020.
(60) Provisional application No. 63/273,418, filed on Oct. 29, 2021.

(51) Int. Cl. H04L 43/0882

(52) U.S. Cl. CPC H04L 43/0882

(57) ABSTRACT

Examples described herein relate to a packet processing device that includes circuitry to: request network resource consumption data from one or more other packet processing devices by indication in a header of a reliable transport protocol and transmit the request in a packet that includes the indication in the header. In some examples, the header includes an option field of a transmission control protocol (TCP) packet. In some examples, the network resource consumption data includes a largest network resource consumption data in a path from a sender to a receiver, and potentially one or more next largest network resource consumption data.

### CLAIM OF PRIORITY

This application is a continuation of prior co-pending U.S. patent application Ser. No. 17/667,415, filed on Feb. 8, 2022 and titled “NETWORK RESOURCE MONITORING,” which claims the benefit of priority of prior U.S. Provisional Application No. 63/273,418, filed Oct. 29, 2021 and titled “HIGH PRECISION CONGESTION CONTROL”. Prior co-pending U.S. patent application Ser. No. 17/667,415 is a continuation-in-part of prior U.S. patent application Ser. No. 17/482,822, filed on Sep. 23, 2021 and titled “RESOURCE CONSUMPTION CONTROL,” now U.S. Pat. No. 12,301,476 issued on Apr. 30, 2025, which claims the benefit of priority of prior U.S. Provisional Application No. 63/130,667, filed on Dec. 26, 2020 and titled “CONGESTION METRIC COMPUTATION”. Each of these prior applications is hereby incorporated herein by reference in their entirety.

### DESCRIPTION

Datacenter networks can deliver high packet throughput with low latency and network stability in order to meet the requirements of applications. In a datacenter, network latency and packet throughput impact the performance of applications. Congestion control (CC) schemes can be utilized to mitigate the effects of congested queues or buffers on packet latency. For some applications, Transmission Control Protocol (TCP) is used as a transport layer. TCP congestion controls can include Data Center Transmission Control Protocol (DCTCP) and Google's Swift. To determine congestion, some CC schemes determine congested queues or buffers using heuristics based on indirect signals such as network latency or the number of packet drops.

High Precision Congestion Control (HPCC) is a congestion control system utilized for remote direct memory access (RDMA) communications that provides congestion metrics. HPCC is described at least in Li et al., “HPCC: High Precision Congestion Control,” SIGCOMM (2019). HPCC leverages in-network telemetry (INT) (e.g., Internet Engineering Task Force (IETF) draft-kumar-ippm-ifa-01, “Inband Flow Analyzer” (February 2019)) to convey precise link load information.

### BRIEF DESCRIPTION OF THE DRAWINGS

FIG. 1 depicts an example of a system with network resource monitoring.

FIG. 2 depicts an example packet processing device.

FIG. 3 depicts an example switch.

FIG. 4 depicts an example packet format.

FIGS. 5A-5C depict example processes.

FIG. 6 depicts an example system.

FIG. 7 depicts an example system.

### DETAILED DESCRIPTION

At least in connection with transmission of packets using a reliable transport protocol, packet processing devices, described herein, can utilize a protocol to transmit and utilize congestion metrics to adjust a transmission rate of packets or modify a path of transit of packets to a receiver. Instead of, in addition to, relying on in-band network telemetry, network resource consumption data can be transported using one or more packet header fields. The one or more packet header fields can be associated with a reliable transport protocol. In accordance with the protocol, network resource consumption data can be generated by switches in a path from a sender packet processing device to a receiver packet processing device and conveyed using one or more packet header fields.

Features such as Generic Receive Offload (GRO) (e.g., Linux or Data Plane Development Kit GRO) and receive coalescing (RSC) (e.g., a feature in Windows Server 2019 and Windows 10 Oct. 2018 Update), that are widely used in TCP-based applications, can introduce additional delay by pre-buffering packets before merging then into larger segments and can delay transmission of congestion information such as network resource consumption data. When using GRO or RSC pre-buffering, circuitry at a sender packet processing device, switch, and/or receiver packet processing device can prioritize transmission of network resource consumption data based on changes to network resource consumption data.

Schemes described herein to convey network resource consumption data can be utilized for communications based on Non-Volatile Memory Express (NVMe) over TCP, or other protocol, such as data read or write requests to NVMe drives or memory or storage pools. Congestion control schemes described herein can be used with HPCC using RDMA. While examples are described with respect to TCP, other protocols can be used such as InfiniBand, Internet Wide Area RDMA Protocol (iWARP), User Datagram Protocol (UDP), quick UDP Internet Connections (QUIC), RDMA over Converged Ethernet (RoCE), Amazon's scalable reliable datagram (SRD), or other reliable transport protocols.

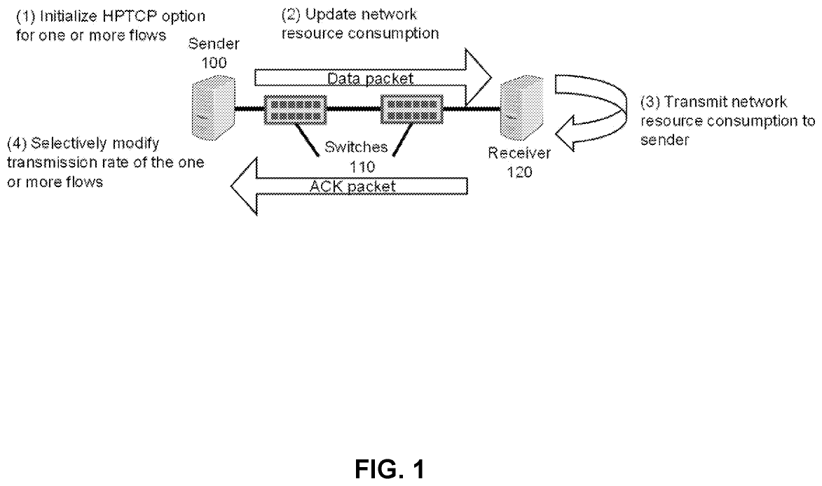

FIG. 1 depicts a high-level view of operation of congestion control using network resource consumption monitoring. An example operation can be as follows. At (1), sender packet processing device 100 initializes an option, applied to one or more flows, to generate and transmit network resource consumption data, as described herein. A congestion metric U, described herein, of the network resource consumption data can be set to a zero value at initialization and transmitted from sender 100 through a path of switches 110 to receiver 120. Sender 100 can utilize a reliable transport protocol to send network resource consumption data through a path via one or more switches 110 to receiver packet processing device 120. For example, the reliable transport protocol can be TCP or other reliable transport protocols. In some examples, a TCP option field can be used to transmit U value and other network resource consumption data to receiver 120. In some examples, in addition or alternative to use of the TCP option field to transmit network resource consumption data, network resource consumption data can be sent in accordance with INT.

A switch of switches 110 can include circuitry to determine network resource consumption data of the switch for at least the one or more flows. Examples of network resource consumption data transmitted from a switch to another switch or receiver 120 can include one or more of: congestion metric (U) value, a level of transit delay of a switch in the path, level of queue depth of a switch in the path from sender 110 to receiver 120, level of buffer occupancy of a switch in the path, or device identifier (e.g., switch or packet processing device Internet Protocol (IP) address). A switch can update network resource consumption data in a packet to include a highest and one or more next highest network resource consumption data. For example, if a local U value determined at the at least one switch is higher in value than the received U value, the switch updates a U value in the received packet before forwarding the received packet to another switch or receiver 120. At (2), at least one switch of switches 110 transmits, to receiver 120, network resource consumption data in at least one packet received from sender 100 or updated network resource consumption data added to a packet received from sender 100. A switch can transmit network resource consumption data using a reliable transport header field of a packet, as described herein.

In some examples, congestion metric (U) can be determined based on qlen*a +txRate*b, where:
qlen can represent a queue length (e.g., number of bytes in a queue that stores received packets (with and without network resource consumption data) that are sent to a same next hop switch or packet processing device),
txRate can represent a transmit rate from a port,
a and b are configurable parameters from a control plane, where
   a can represent (cell_size*sFactor)/(B*T),
   cell_size can represent the size of cells used in the queueing system to store packet data in the packet buffer and a cell can indicate a number of bytes (e.g., 64 Bytes or other values),
   B can represent link bandwidth, per switch and port,
   T can represent congestion-free round trip time (RTT) for a longest hop distance in a connection between the sender and receiver through one or more switches,
   b=sFactor/B, and
   sFactor can represent a scale factor used to normalize inflight_bytes as an integer.
      sFactor can control resolution of link utilization and can be consistent across the switches and network devices in a path in which network resource consumption data are measured and propagated. In some examples, sFactor=2³ and an integer 8 can used to represent a case when queue length (qlen)=0 and link_util=100%. An integer value 16 can represent a case where qlen=Bandwidth Delay Product (BxT) and link_util=100%.

At (3), receiver 120 can receive network resource consumption data and copy received network resource consumption data into a second packet to be transmitted to the sender. In some examples, the second packet includes an acknowledgement (ACK) of receipt of a packet transmitted by sender 100 and that includes network resource consumption data or updated network resource consumption data. Receiver 120 can send the second packet to sender 100 via one or more switches 110 or other switches or devices. Receiver 120 can transmit network resource consumption data using a reliable transport header field of the second packet, as described herein.

In some cases, receiver 120 is congested due to congestion in a device interface (e.g., PCIe) from receiver 120 to a host server or direct memory access (DMA) circuitry from receiver 120 to a host server (not depicted) and/or bottleneck in stack or application processing. Such congestion or bottleneck at receiver 120 and its host can lead to increased RTTs from sender 100 to receiver 120. In turn, the sender's congestion window can increase. In some examples, receiver 120 can send congestion data associated with congestion at receiver packet processing device 120 and/or its host. For example, congestion data associated with congestion at receiver packet processing device 120 and/or its host can include a difference, change, or direction (e.g., increase, steady, or decrease) of packet polling rate. The packet polling rate can be provided by the host operating system (OS) to the driver of receiver packet processing device 120. For example, a decreasing polling budget is a signal of congestion at the host that processes packets from receiver packet processing device 120. For example, an increasing polling budget is a signal congestion is reducing at the host that processes packets from receiver packet processing device 120. Packet polling rate related data can be transmitted from receiver 120, with network resource consumption data, to sender 100. As a result, sender 100 can react both to network and host congestion.

At receiver 120 and/or one or more of switches 110, generic receive offload (GRO) or other packet coalescing feature can aggregate packet content into fewer, but potentially larger packets. However, a change in U value or other packet header information can cause receiver 120 to terminate use of GRO or other packet coalescing features. In some cases, receiver 120 and/or one or more of switches 110 includes or utilizes circuitry to determine if network resource consumption data changes more than a threshold amount. During use of coalescing at receiver 120, if network resource consumption data changes more than a threshold amount, receiver 120 and/or one or more of switches 110 includes the network resource consumption data in a packet transmitted to sender 100. In such case, a TCP urgent (URG) value can be set to cause or force transmission of an ACK packet with network resource consumption data without meeting coalescing levels to reduce delay of transmission of the network resource consumption data to sender 100. Such network resource consumption data could lead to changes in transmission behavior of sender 100, as described herein.

However, during use of coalescing at receiver 120, if network resource consumption data changes (e.g., absolute value of change) at or less than a threshold amount from network resource consumption data previously transmitted to sender 100, receiver 120 does not force a transmission of a packet that includes the network resource consumption data to sender 100. The transmission of network resource consumption data to sender 100 can be delayed, as a result of using coalescing, but as such network resource consumption data has not changed more than a threshold amount from network resource consumption data previously transmitted to sender 100, transmission of such network resource consumption data may be low priority as it may not cause a change in transmission activity of sender 100.

As described herein, sender 100 can send to receiver 120, network resource consumption data previously transmitted to sender 100 in a Uprv field of a packet header. Receiver 120 and/or one or more of switches 110 can compare the network resource consumption data previously transmitted to sender 100 with most recently received or determined network resource consumption data in order to determine whether to force GRO or RSC flush so that, based on passing a threshold level of change, receiver 120 can send network resource consumption data to sender 100. In some examples, receiver 120 can store network resource consumption data previously transmitted to sender 100 and use such stored network resource consumption data previously transmitted to sender 100 as a basis for determining whether to force a transmission of network resource consumption data to sender 100. In some cases, where coalescing is used, TCP per-flow state tracking need not be maintained to determine whether to force a transmission of network resource consumption data to sender 100.

Where coalescing is used, a switch (e.g., last hop in the network of switches 110 before receiver 120) or receiver 120 can perform the following operation to determine the network resource consumption data to send to sender 100:
if (pkt.Uval<(pkt.Uprv−U_margin_low))||
   (pkt.Uval>(pkt.Uprv+U_margin_high)):
      pkt.TCP.URG=1
else:
   pkt.Uval=pkt.Uprv

Pre-buffering and coalescing can be terminated (pkt.TCP.URG=1) and packets transmitted or delivered without further delay in case there is change in network resource consumption data as defined by network resource consumption data changing more than margin U_margin_low or U_margin_high from a previously observed or received network resource consumption data. However, pre-buffering and coalescing can continue and not terminate pre-maturely in case network resource consumption data does not change more than margin U_margin_low or U_margin_high from a previously observed network resource consumption data.

At (4), sender 100 can receive network resource consumption data from receiver 120 and perform congestion control. For example, based on received network resource consumption data and determined RTT between sender 100 and receiver 120, sender 100 can adjust Congestion Window (CNWND) to adjust a transmit rate of packets of a flow transmitted to a congested queue or switch associated with received network resource consumption data. Adjusting a transmit rate can increase or decrease the transmission rate. For example, based on received network resource consumption data and RTT, sender 100 can pause transmission of packets to a congested queue or transmit packets on an alternate path to avoid a congested packet processing device. In some examples, a host communicatively coupled to sender 100 can utilize Linux TCP tracing tool to access host and fabric information to determine transmit rate and/or perform a path change for a flow based on received network resource consumption data as well as RTT.

A packet in a flow can include a same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. In some examples, a flow can have its own time domain relative to main timer or other clock sources.

In a case where sender 100 sends a sequence of packets with a same previously received network resource consumption data (Uprv) and a switch updates received network resource consumption data, packets in the sequence can be marked with TCP. URG flag until the echo packets are returned to sender 100. However, GRO or RSC performance can be negatively impacted as packets in the sequence are promptly transmitted without an attempt to coalesce packets despite network resource consumption data not changing or not changing by more than a threshold amount. In some examples, sender 100 can utilize GRO or RSC and where a sequence of packets with a same previously received network resource consumption data, sender 100 can mark a first packet of a Transmit Segmentation Offload/Generic Segmentation Offload (TSO/GSO) session is modified. For example, sender 100 can set a Uprv value of the first packet to a non-zero value and set Uprv of zero for other packets in the sequence.

In some examples, receiver 120 and/or one or more of switches 110 can perform operations in the following pseudocode:
if (pkt.Uprv && (pkt.Uval<(pkt.Uprv−U_margin_low))||
   (pkt.Uval>(pkt.Uprv+U_margin_high))):
      pkt.TCP.URG=1
         For a non-zero Uprv and change in the network resource consumption data from a network resource consumption data in a prior packet that is more than U_margin_low and U_margin_high, the first packet can be marked as urgent transmission (pkt. TCP. URG=1) and immediately processed by the receive stack and ACK packet carrying the updated network resource consumption data is promptly sent to sender 100. Packets with zero Uprv and a change in the network resource consumption data from a network resource consumption data in a prior packet that is less than or equal to U_margin_low and U_margin_high can be coalesced with other packets.

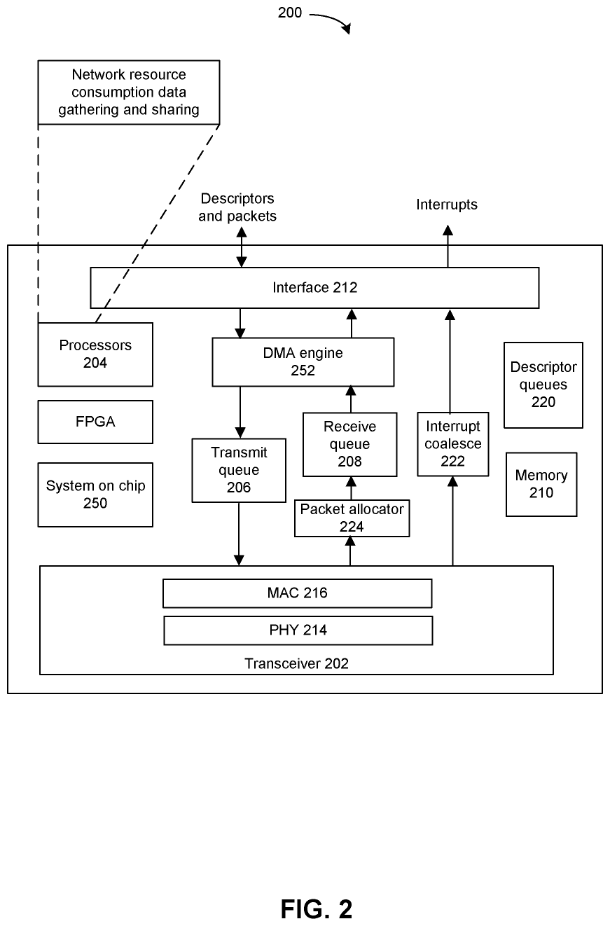

FIG. 2 depicts an example packet processing device. A packet processing device can be implemented as one or more of: a network interface controller (NIC) (e.g., endpoint receiver NIC or NIC in a path from sender to receiver), a remote direct memory access (RDMA)-enabled NIC, SmartNIC, router, switch, forwarding element, infrastructure processing unit (IPU), data processing unit (DPU). The packet processing device can be used as a sender or receiver packet processing device and can request network resource consumption data, process network resource consumption data, and/or transmit, as described herein.

Packet processing device 200 can include transceiver 202, processors 204, transmit queue 206, receive queue 208, memory 210, and bus interface 212, and DMA engine 252. Transceiver 202 can be capable of receiving and transmitting packets in conformance with the applicable protocols such as Ethernet as described in IEEE 802.3, although other protocols may be used. Transceiver 202 can receive and transmit packets from and to a network via a network medium (not depicted). Transceiver 202 can include PHY circuitry 214 and media access control (MAC) circuitry 216. PHY circuitry 214 can include encoding and decoding circuitry (not shown) to encode and decode data packets according to applicable physical layer specifications or standards. MAC circuitry 216 can be configured to assemble data to be transmitted into packets, that include destination and source addresses along with network control information and error detection hash values.

Processors 204 can be any a combination of a: processor, core, graphics processing unit (GPU), field programmable gate array (FPGA), application specific integrated circuit (ASIC), or other programmable hardware device that allow programming of packet processing device 200. For example, a “smart network interface” can provide packet processing capabilities in the packet processing device using processors 204. Configuration of operation of processors 204, including its data plane, can be programmed using Programming Protocol-independent Packet Processors (P4), C, Python, Broadcom Network Programming Language (NPL), or x86 compatible executable binaries or other executable binaries. Processors 204 and/or system on chip 250 can request network resource consumption data, process network resource consumption data, and/or transmit network resource consumption data, as described herein.

Packet allocator 224 can provide distribution of received packets for processing by multiple CPUs or cores using timeslot allocation described herein or RSS. When packet allocator 224 uses RSS, packet allocator 224 can calculate a hash or make another determination based on contents of a received packet to determine which CPU or core is to process a packet.

Interrupt coalesce 222 can perform interrupt moderation whereby interrupt coalesce 222 waits for multiple packets to arrive, or for a time-out to expire, before generating an interrupt to host system to process received packet(s). Receive Segment Coalescing (RSC) can be performed by packet processing device 200 whereby portions of incoming packets are combined into segments of a packet. Packet processing device 200 can provide this coalesced packet to an application.

Direct memory access (DMA) engine 252 can copy a packet header, packet payload, and/or descriptor directly from host memory to the packet processing device or vice versa, instead of copying the packet to an intermediate buffer at the host and then using another copy operation from the intermediate buffer to the destination buffer.

Memory 210 can be any type of volatile or non-volatile memory device and can store any queue or instructions used to program packet processing device 200. Transmit queue 206 can include data or references to data for transmission by packet processing device. Receive queue 208 can include data or references to data that was received by packet processing device from a network. Descriptor queues 220 can include descriptors that reference data or packets in transmit queue 206 or receive queue 208. Bus interface 212 can provide an interface with host device (not depicted). For example, bus interface 212 can be compatible with PCI, PCI Express, PCI-x, Serial ATA, and/or USB compatible interface (although other interconnection standards may be used).

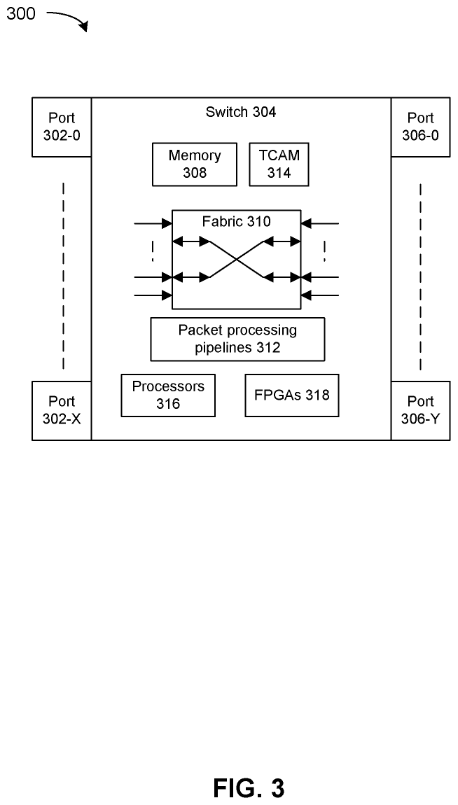

FIG. 3 depicts an example switch. Switch 300 can determine network resource consumption data and propagate network resource consumption data in at least one packet, as described herein. Switch 304 can route packets or frames of any format or in accordance with any specification from any port 302-0 to 302-X to any of ports 306-0 to 306-Y (or vice versa). Any of ports 302-0 to 302-X can be connected to a network of one or more interconnected devices. Similarly, any of ports 306-0 to 306-Y can be connected to a network of one or more interconnected devices.

In some examples, switch fabric 310 can provide routing of packets from one or more ingress ports for processing prior to egress from switch 304. Switch fabric 310 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 308 can be configured to store packets received at ports prior to egress from one or more ports. Packet processing pipelines 312 can determine which port to transfer packets or frames to using a table that maps packet characteristics with an associated output port. Packet processing pipelines 312 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry. Packet processing pipelines 312 can implement access control list (ACL) or packet drops due to queue overflow. Packet processing pipelines 312 can be configured to determine network resource consumption data for switch 300 and propagate in at least one packet, network resource consumption data or a number of worst, next worst, and so forth network resource consumption data, as described herein.

Configuration of operation of packet processing pipelines 312, including its data plane, can be programmed using P4, C, Python, Broadcom Network Programming Language (NPL), or x86 compatible executable binaries or other executable binaries. Processors 316 and FPGAs 318 can be utilized for packet processing or modification.

Switch 300 may be implemented as any type of device or collection of devices capable of performing the various compute functions as described herein. In some examples, switch may be implemented as a single device such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the operations described herein. Additionally, in some examples, switch may include, or may be implemented as, one or more processors and memory.

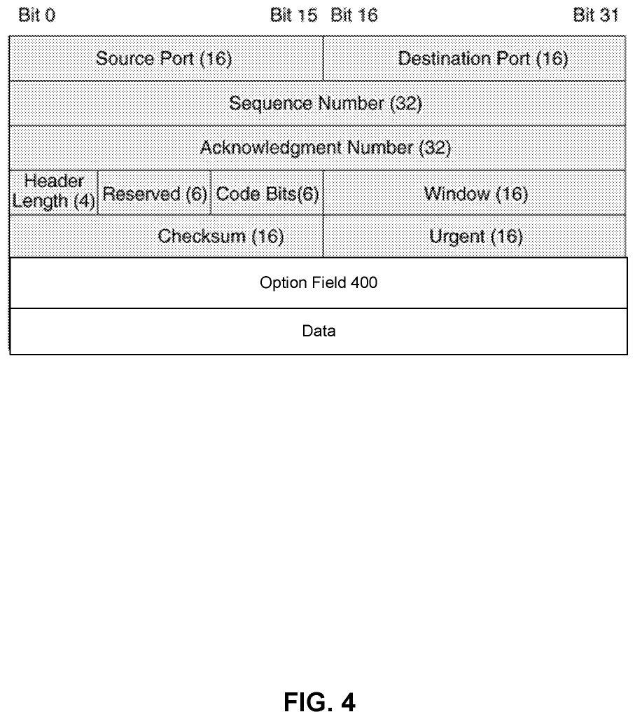

FIG. 4 depicts an example packet format. In some examples, TCP header option field 400 can include various data used to convey network resource consumption. For example, various data can include one or more of: Option-kind, Option-length, or Option-data. Various examples of field sizes and values are exemplary and other sizes and values can be used. Option-kind (e.g., 1B) can identify that the TCP option field is used to convey network resource consumption data. Option-length (e.g., 1B) can identify an overall size of option field 400.

Option-data (e.g., 2B/6B) can include one or more of: (1) U Value (Uval); (2) U Value Echo Reply (Uecr); or (3) U Value Previous (Uprv). A sender can initialize a U Value to 0 and switches can update U value as described herein or forward the U Value. The receiver can copy the U Value into a U Value Echo Reply sent to the sender.

Instead of using Uval for congestion control, a sender may use it as a telemetry data to aid traffic monitoring and debugging. In this mode of operation, Uval extends TCP connection state that includes data such as current congestion window, round trip time (RTT), throughput, etc. Network administrators can use this information to analyze current state of congestion in the network. In this mode, option field 400 can include one or more of: option-kind (e.g., 1B); Option-length (1B); or Option-data (4B/8B). Option-data can include one or more of: U Value, U Value Echo Reply, reserved/U Value Previous, Switch ID, and/or Switch ID Echo Reply.

Switch ID can identify a switch associated with transmitted network resource consumption data. Thus, a node with highest congestion can be identified. In some examples, a sender and/or receiver can use an Internet Protocol (IP) Time to live (TTL) field to transmit the Switch ID.

Switch ID Echo Reply can be used by receiver when sending an ACK or otherwise transmitting network resource consumption data to a sender.

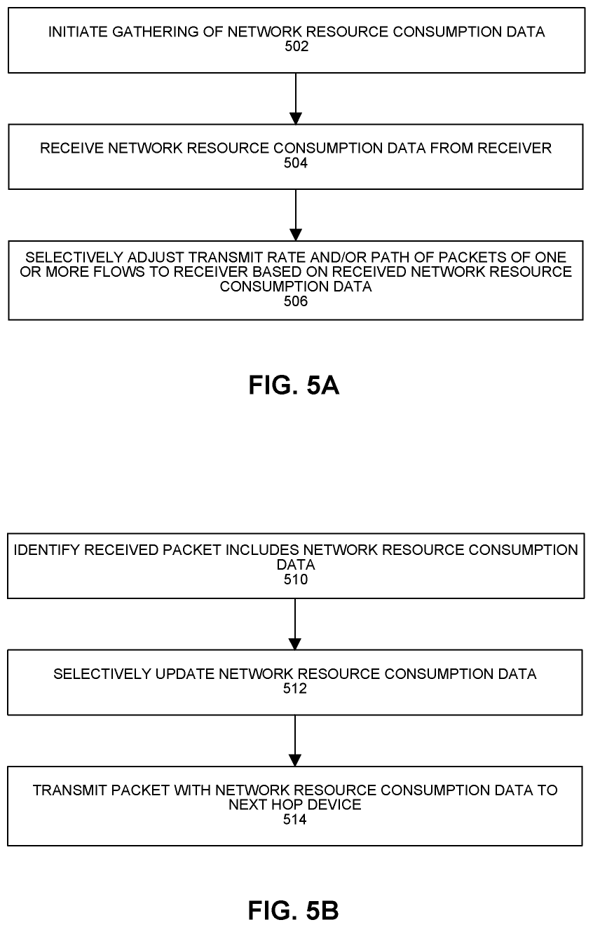

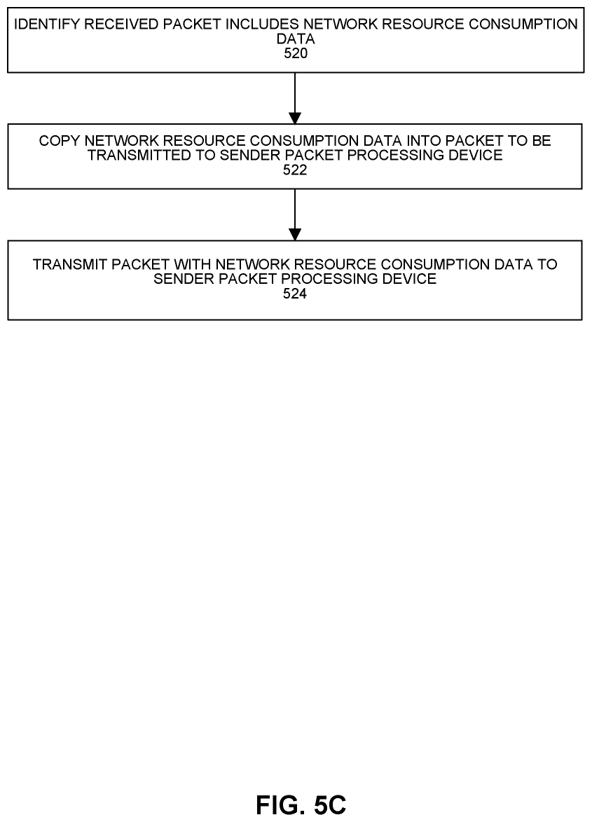

FIG. 5A depicts an example process. The process can be performed by a sender packet processing device. At 502, a sender packet processing device initializes gathering of network resource consumption data by one or more switches in a path of packets of one or more flows to a receiver. The receiver can send the gathered network resource consumption data to the sender packet processing device. At 504, the sender packet processing device receives network resource consumption data from the receiver. Network resource consumption data can be highest network resource consumption data determined by one or more switches along a path from the sender to receiver. Network resource consumption data can include one or more of: a level of transit delay of a switch in the path, level of queue depth of a switch in a path from sender to receiver, level of buffer occupancy of a switch in the path, switch or packet processing device identifier, or other information. At 506, the sender packet processing device can adjust a transmit rate of packets of one or more flows based on received network resource consumption data. For example, the sender packet processing device can adjust a transmit rate of packets by updating a congestion window size. A Linux TCP tracing tool can be used to access host and network resource consumption data to determine transmit rate and/or path change for one or more flows based on received network resource consumption data.

FIG. 5B depicts an example process. The process can be performed by one or more switches. At 510, a switch can identify that a received packet includes network resource consumption data. In some examples, the switch can identify that a packet incudes network resource consumption data based on content of a packet header field. At 512, the switch updates network resource consumption data in the received packet if network resource consumption data of the switch is higher than the network resource consumption data in the received packet. At 514, the switch can send the packet with network resource consumption data to a next switch in a path to a receiver or to the receiver.

FIG. 5C depicts an example process. The process can be performed by a receiver packet processing device. At 520, the receiver packet processing device can identify a received packet that includes network resource consumption data. The receiver packet processing device can identify that the packet incudes network resource consumption data based on content in one or more header fields. At 522, the receiver packet processing device can copy the received network resource consumption data into one or more packets to be transmitted to the sender packet processing device. In some examples, the sender packet processing device can include network resource consumption data in an acknowledgement (ACK) of receipt of a packet transmitted by the sender packet processing device. At 524, the receiver packet processing device can transmit the one or more packets with network resource consumption to the sender packet processing device. In cases where the receiver packet processing device utilizes generic receive offload (GRO) or other packet coalescing feature, the receiver packet processing device can force transmission of a packet with network resource consumption data based on a change in network resource consumption data from a previously transmitted network resource consumption data.

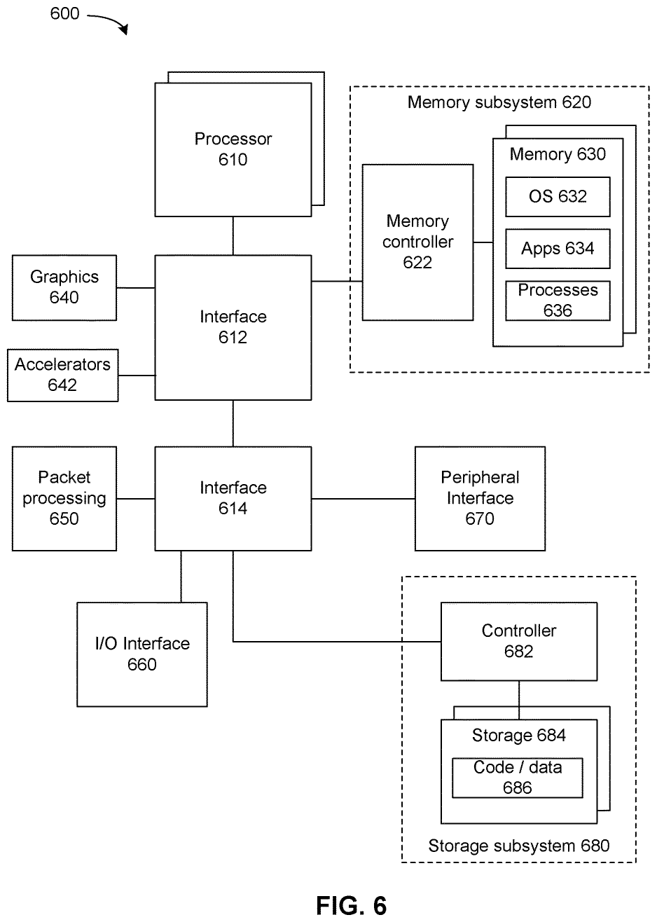

FIG. 6 depicts a system. The system can use examples described herein to cause transmission of a packet with network resource consumption data to a sender, request network resource consumption data, and/or modify transmission of packets based on received network resource consumption data, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some examples, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Broadcom®, Nvidia®, Texas Instruments®, among others. In some examples, a driver can advertise capability of packet processing device 650 and/or enable packet processing device 650 to transmit a packet with network resource consumption data to a sender, request network resource consumption data, and/or modify transmission of packets based on received network resource consumption data, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Packet processing device 650 provides system 600 the ability to communicate with remote devices (e.g., servers or other computing devices) over one or more networks. Packet processing device 650 can include an Ethernet adapter, wireless interconnection components, cellular network interconnection components, USB (universal serial bus), or other wired or wireless standards-based or proprietary interfaces. Packet processing device 650 can transmit data to a device that is in the same data center or rack or a remote device, which can include sending data stored in memory. Packet processing device 650 can receive data from a remote device, which can include storing received data into memory.

Some examples of packet processing device 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a packet processing device with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Processor 610 and packet processing device 650 can offload, to a switch, determination of nodes to execute microservices of a service mesh and select a memory pool or device to store data and state associated with or generated by microservices of the service mesh. In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as standards released by JEDEC (Joint Electronic Device Engineering Council) on Jun. 27, 2007).

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, packet processing devices, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, packet processing device and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

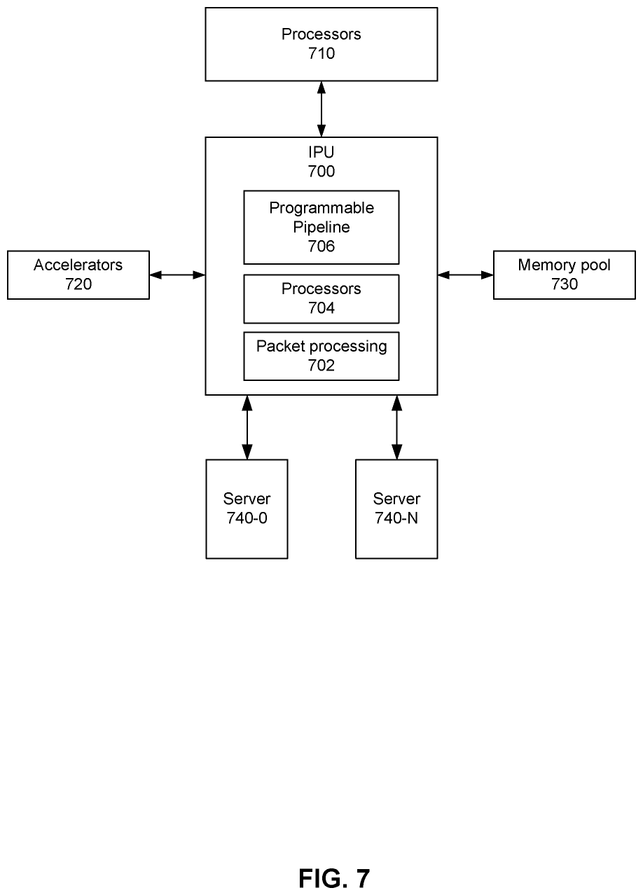

FIG. 7 depicts an example system. In this system, IPU 700 manages performance of one or more processes using one or more of processors 710, accelerators 720, memory pool 730, or servers 740-0 to 740-N, where N is an integer of 1 or more. In some examples, processors 704 of IPU 700 can execute one or more processes, applications, VMs, containers, microservices, and so forth that request performance of workloads by one or more of: processors 710, accelerators 720, memory pool 730, and/or servers 740-0 to 740-N. IPU 700 can utilize packet processing device 702 or one or more device interfaces to communicate with processors 710, accelerators 720, memory pool 730, and/or servers 740-0 to 740-N. IPU 700 can utilize programmable pipeline 704 to process packets that are to be transmitted from packet processing device 702 or packets received from packet processing device 702. In some examples, IPU 700 can cause one or more devices to collect network resource consumption data and transmit network resource consumption data to IPU 700, as described herein. IPU 700 can manage transmissions of packets based on received network resource consumption data.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An example of the devices, systems, and methods may include any one or more, and any combination of, the examples described below.

Example 1 includes one or more examples, and includes an apparatus comprising: a packet processing device comprising circuitry to: request network resource consumption data from one or more other packet processing devices by indication in a header of a reliable transport protocol and transmit the request in a packet that includes the indication in the header.

Example 2 includes one or more examples, wherein the header comprises an option field of a transmission control protocol (TCP) packet.

Example 3 includes one or more examples, wherein the network resource consumption data comprises a largest network resource consumption data in a path from a sender to a receiver.

Example 4 includes one or more examples, wherein the circuitry is to include a previously received network resource consumption data in the header to provide a reference network resource consumption data level from which to determine whether to adjust network resource consumption data included in a packet.

Example 5 includes one or more examples, wherein the network resource consumption data includes one or more of: congestion metric (U) value, a level of transit delay of a switch in a path from a sender to a receiver, level of queue depth of a switch in the path, level of buffer occupancy of a switch in the path, device identifier associated with network resource consumption data, data copy latency between a receiver packet processing device and host, or device identifier.

Example 6 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 7 includes one or more examples, and includes a switch, wherein the switch comprises circuitry to adjust network resource consumption data in a packet to be forwarded based on a value of network resource consumption data measured at the switch relative to a previous value of network resource consumption data.

Example 8 includes one or more examples, and includes a receiver packet processing device comprising circuitry that is to: during a packet coalescing state, permit packet transmission based on a change in network resource consumption data.

Example 9 includes one or more examples, wherein the packet processing device comprises circuitry to selectively modify a transmit rate and/or path of packets of a flow based on received network resource consumption data.

Example 10 includes one or more examples, and a server communicatively coupled to the packet processing device, wherein the server is to cause the packet processing device to request network resource consumption data from one or more other packet processing devices by indication in a header of a reliable transport protocol.

Example 11 includes one or more examples, and includes a datacenter, wherein the datacenter includes the packet processing device, one or more switches in a path to a receiver packet processing device, and the receiver packet processing device.

Example 12 includes one or more examples, and includes at least one non-transitory computer-readable medium, comprising instructions stored thereon, that if executed by at least one processor, cause the at least one processor to: configure a sender packet processing device to selectively modify a transmit rate of packets based on network resource consumption data received in a packet header.

Example 13 includes one or more examples, and includes instructions stored thereon, that if executed by the at least one processor, cause the at least one processor to: cause one or more packet processing devices to utilize a protocol to generate and transmit network resource consumption data, in packet header, to the sender packet processing device.

Example 14 includes one or more examples, wherein the network resource consumption data includes one or more of: congestion metric (U) value, a level of transit delay of a switch in a path from the sender packet processing device to a receiver, level of queue depth of a switch in the path, level of buffer occupancy of a switch in the path, device identifier associated with network resource consumption data, data copy latency between a receiver packet processing device and host, or device identifier.

Example 15 includes one or more examples, wherein the sender packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 16 includes one or more examples, and includes a method comprising: requesting, at a packet processing device, network resource consumption data from one or more other packet processing devices by indication in a header of a reliable transport protocol and transmitting, from the packet processing device, the request in a packet that includes the indication in the header.

Example 17 includes one or more examples, wherein the header comprises an option field of a transmission control protocol (TCP) packet.

Example 18 includes one or more examples, wherein the network resource consumption data comprises a largest network resource consumption data in a path from a sender to a receiver.

Example 19 includes one or more examples, and includes including a previously received network resource consumption data in the header to provide a reference network resource consumption data level from which to determine whether to adjust network resource consumption data included in a packet.

Example 20 includes one or more examples, wherein the network resource consumption data includes one or more of: congestion metric (U) value, a level of transit delay of a switch in a path from a sender to a receiver, level of queue depth of a switch in the path, level of buffer occupancy of a switch in the path, device identifier associated with network resource consumption data, data copy latency between a receiver packet processing device and host, or device identifier.

What is claimed is:

1. Integrated circuit for use in association with ternary content-addressable memory (TCAM) in a network switch, the network switch being configurable for use in a network that comprises multiple server systems and multiple network switch systems, the multiple server systems comprising at least one server system and at least one other server system, the multiple network switch systems comprising at least one network switch system and at least one other network switch system, the network switch to be comprised in the at least one network switch system, the integrated circuit comprising:
programmable packet processing pipeline circuitry configurable to implement multiple programmable pipelines, the multiple programmable pipelines to perform match-action operations based upon received packet data and table data, the table data to be stored, at least in part, in the TCAM to identify packet processing rule data and/or next hops;
wherein:
the integrated circuit is to generate, in response, at least in part, to request packet data, network resource consumption-related data for use in generating packet flow transmit-rate information for at least one packet flow transmitted from the at least one server system in the network;
the request packet data is to be identified by the integrated circuit as requesting the network resource consumption-related data, based, at least in part, upon header data of the request packet data;
the packet flow transmit-rate information is to be used by the at least one server system to adjust flow-rate of the at least one packet flow from the at least one server system in the network;
the network resource consumption-related data is to be updated, based upon additional network resource consumption-related data from the at least one other network switch system, to generate updated network resource consumption-related data;
the updated network resource consumption-related data is (1) to be provided to the at least one other server system and (2) for use in generating the packet flow transmit-rate information by the at least one other server system;
the updated network resource consumption-related data comprises:
switch queue depth information associated with the at least one network switch system and/or the at least one other network switch system;
switch transit delay-related information associated with the at least one network switch system and/or the at least one other network switch system; and
switch identification information associated with the at least one network switch system and/or the at least one other network switch system;
the updated network resource consumption-related data is to be provided, via acknowledge (ACK) packet data, to the at least one server system from the at least one other server system; and
the flow-rate of the at least one packet flow from the at least one server system in the network is to be adjusted, based upon the packet flow transmit-rate information, in association with implementing network congestion control associated with the at least one packet flow.

2. The integrated circuit of claim 1, wherein:
the at least one packet flow is to be identified based upon protocol tuple information; and
the protocol tuple information comprises packet header information.

3. The integrated circuit of claim 2, wherein:
at least one other portion of the table data comprises exact match table data.

4. The integrated circuit of claim 3, wherein:
the flow-rate of the at least one packet flow from the at least one server system in the network comprises a remote direct memory access (RDMA) over converged Ethernet (RoCE) traffic flow rate;
the network congestion control is compatible with High Precision Congestion Control (HPCC); and
the network resource consumption-related data that is to be generated by the integrated circuit and/or the updated network resource consumption-related data are associated, at least in part, with Internet Engineering Task Force (IETF) Inband Flow Analyzer (IFA) telemetry information.

5. The integrated circuit of claim 4, wherein:
the integrated circuit is comprised in an application specific integrated circuit;
the programmable packet processing pipeline circuitry comprises a data plane; and
the programmable packet processing pipeline circuitry and the data plane are programmable using Network Programming Language (NPL).

6. The integrated circuit of claim 4, wherein:
the integrated circuit is to generate the updated network resource consumption-related data; and
the at least one switch system is to provide the updated network resource consumption-related data to the at least one other server system.

7. The integrated circuit of claim 1, wherein:
the network switch is to be comprised in one of the multiple server systems.

8. A method implemented using an integrated circuit, the integrated circuit being configurable for use in association with ternary content-addressable memory (TCAM) in a network switch, the network switch being configurable for use in a network that comprises multiple server systems and multiple network switch systems, the multiple server systems comprising at least one server system and at least one other server system, the multiple network switch systems comprising at least one network switch system and at least one other network switch system, the network switch to be comprised in the at least one network switch system, the integrated circuit comprising programmable packet processing pipeline circuitry, the programmable packet processing pipeline circuitry being configurable to implement multiple programmable pipelines, the method comprising:
using the multiple programmable pipelines to perform match-action operations based upon received packet data and table data, the table data to be stored, at least in part, in the TCAM to identify packet processing rule data and/or next hops;
wherein:
the integrated circuit is to generate, in response, at least in part, to request packet data, network resource consumption-related data for use in generating packet flow transmit-rate information for at least one packet flow transmitted from the at least one server system in the network;
the request packet data is to be identified by the integrated circuit as requesting the network resource consumption-related data, based, at least in part, upon header data of the request packet data;
the packet flow transmit-rate information is to be used by the at least one server system to adjust flow-rate of the at least one packet flow from the at least one server system in the network;
the network resource consumption-related data is to be updated, based upon additional network resource consumption-related data from the at least one other network switch system, to generate updated network resource consumption-related data;
the updated network resource consumption-related data is (1) to be provided to the at least one other server system and (2) for use in generating the packet flow transmit-rate information by the at least one other server system;
the updated network resource consumption-related data comprises:
switch queue depth information associated with the at least one network switch system and/or the at least one other network switch system;
switch transit delay-related information associated with the at least one network switch system and/or the at least one other network switch system; and
switch identification information associated with the at least one network switch system and/or the at least one other network switch system;
the updated network resource consumption-related data is to be provided, via acknowledge (ACK) packet data, to the at least one server system from the at least one other server system; and
the flow-rate of the at least one packet flow from the at least one server system in the network is to be adjusted, based upon the packet flow transmit-rate information, in association with implementing network congestion control associated with the at least one packet flow.

9. The method of claim 8, wherein:
the at least one packet flow is to be identified based upon protocol tuple information; and
the protocol tuple information comprises packet header information.

10. The method of claim 9, wherein:
at least one other portion of the table data comprises exact match table data.

11. The method of claim 10, wherein:
the flow-rate of the at least one packet flow from the at least one server system in the network comprises a remote direct memory access (RDMA) over converged Ethernet (RoCE) traffic flow rate;
the network congestion control is compatible with High Precision Congestion Control (HPCC); and
the network resource consumption-related data that is to be generated by the integrated circuit and/or the updated network resource consumption-related data are associated, at least in part, with Internet Engineering Task Force (IETF) Inband Flow Analyzer (IFA) telemetry information.

12. The method of claim 11, wherein:
the integrated circuit is comprised in an application specific integrated circuit;
the programmable packet processing pipeline circuitry comprises a data plane; and
the programmable packet processing pipeline circuitry and the data plane are programmable using Network Programming Language (NPL).

13. The method of claim 11, wherein:
the integrated circuit is to generate the updated network resource consumption-related data; and
the at least one switch system is to provide the updated network resource consumption-related data to the at least one other server system.

14. The method of claim 8, wherein:
the network switch is to be comprised in one of the multiple server systems.

15. At least one non-transitory machine-readable storage medium storing instructions to be executed by at least one machine associated with an integrated circuit, the integrated circuit being configurable for use in association with ternary content-addressable memory (TCAM) in a network switch, the network switch being configurable for use in a network that comprises multiple server systems and multiple network switch systems, the multiple server systems comprising at least one server system and at least one other server system, the multiple network switch systems comprising at least one network switch system and at least one other network switch system, the network switch to be comprised in the at least one network switch system, the integrated circuit comprising programmable packet processing pipeline circuitry, the programmable packet processing pipeline circuitry being configurable to implement multiple programmable pipelines, the instructions, when executed, by the at least one machine, resulting in performance of operations comprising:
performing, by the multiple programmable pipelines, match-action operations based upon received packet data and table data, the table data to be stored, at least in part, in the TCAM to identify packet processing rule data and/or next hops;
wherein:
the integrated circuit is to generate, in response, at least in part, to request packet data, network resource consumption-related data for use in generating packet flow transmit-rate information for at least one packet flow transmitted from the at least one server system in the network;
the request packet data is to be identified by the integrated circuit as requesting the network resource consumption-related data, based, at least in part, upon header data of the request packet data;
the packet flow transmit-rate information is to be used by the at least one server system to adjust flow-rate of the at least one packet flow from the at least one server system in the network;
the network resource consumption-related data is to be updated, based upon additional network resource consumption-related data from the at least one other network switch system, to generate updated network resource consumption-related data;
the updated network resource consumption-related data is (1) to be provided to the at least one other server system and (2) for use in generating the packet flow transmit-rate information by the at least one other server system;
the updated network resource consumption-related data comprises:
switch queue depth information associated with the at least one network switch system and/or the at least one other network switch system;
switch transit delay-related information associated with the at least one network switch system and/or the at least one other network switch system; and
switch identification information associated with the at least one network switch system and/or the at least one other network switch system;
the updated network resource consumption-related data is to be provided, via acknowledge (ACK) packet data, to the at least one server system from the at least one other server system; and
the flow-rate of the at least one packet flow from the at least one server system in the network is to be adjusted, based upon the packet flow transmit-rate information, in association with implementing network congestion control associated with the at least one packet flow.

16. The at least one non-transitory machine-readable storage medium of claim 15, wherein:
the at least one packet flow is to be identified based upon protocol tuple information; and
the protocol tuple information comprises packet header information.

17. The at least one non-transitory machine-readable storage medium of claim 16, wherein:
at least one other portion of the table data comprises exact match table data.

18. The at least one non-transitory machine-readable storage medium of claim 17, wherein:
the flow-rate of the at least one packet flow from the at least one server system in the network comprises a remote direct memory access (RDMA) over converged Ethernet (RoCE) traffic flow rate;
the network congestion control is compatible with High Precision Congestion Control (HPCC); and
the network resource consumption-related data that is to be generated by the integrated circuit and/or the updated network resource consumption-related data are associated, at least in part, with Internet Engineering Task Force (IETF) Inband Flow Analyzer (IFA) telemetry information.

19. The at least one non-transitory machine-readable storage medium of claim 18, wherein:
the integrated circuit is comprised in an application specific integrated circuit;
the programmable packet processing pipeline circuitry comprises a data plane; and
the programmable packet processing pipeline circuitry and the data plane are programmable using Network Programming Language (NPL).

20. The at least one non-transitory machine-readable storage medium of claim 18, wherein:
the integrated circuit is to generate the updated network resource consumption-related data; and
the at least one switch system is to provide the updated network resource consumption-related data to the at least one other server system.

21. The at least one non-transitory machine-readable storage medium of claim 15, wherein:
the network switch is to be comprised in one of the multiple server systems.

22. A network switch configurable for use in a network that comprises multiple server systems and multiple network switch systems, the multiple server systems comprising at least one server system and at least one other server system, the multiple network switch systems comprising at least one network switch system and at least one other network switch system, the network switch to be comprised in the at least one network switch system, the network switch comprising:
multiple ports to be communicatively coupled to the network; and
an integrated circuit for use in association with ternary content-addressable memory (TCAM), the integrated circuit being communicatively coupled to the multiple ports, the integrated circuit comprising:
programmable packet processing pipeline circuitry configurable to implement multiple programmable pipelines, the multiple programmable pipelines to perform match-action operations based upon received packet data and table data, the table data to be stored, at least in part, in the TCAM to identify packet processing rule data and/or next hops;
wherein:
the integrated circuit is to generate, in response, at least in part, to request packet data, network resource consumption-related data for use in generating packet flow transmit-rate information for at least one packet flow transmitted from the at least one server system in the network;
the request packet data is to be identified by the integrated circuit as requesting the network resource consumption-related data, based, at least in part, upon header data of the request packet data;
the packet flow transmit-rate information is to be used by the at least one server system to adjust flow-rate of the at least one packet flow from the at least one server system in the network;
the network resource consumption-related data is to be updated, based upon additional network resource consumption-related data from the at least one other network switch system, to generate updated network resource consumption-related data;
the updated network resource consumption-related data is (1) to be provided to the at least one other server system and (2) for use in generating the packet flow transmit-rate information by the at least one other server system;
the updated network resource consumption-related data comprises:
switch queue depth information associated with the at least one network switch system and/or the at least one other network switch system;
switch transit delay-related information associated with the at least one network switch system and/or the at least one other network switch system; and
switch identification information associated with the at least one network switch system and/or the at least one other network switch system;
the updated network resource consumption-related data is to be provided, via acknowledge (ACK) packet data, to the at least one server system from the at least one other server system; and
the flow-rate of the at least one packet flow from the at least one server system in the network is to be adjusted, based upon the packet flow transmit-rate information, in association with implementing network congestion control associated with the at least one packet flow.

23. The network switch of claim 22, wherein:
the at least one packet flow is to be identified based upon protocol tuple information; and
the protocol tuple information comprises packet header information.

24. The network switch of claim 23, wherein:
at least one other portion of the table data comprises exact match table data.

25. The network switch of claim 24, wherein:
the flow-rate of the at least one packet flow from the at least one server system in the network comprises a remote direct memory access (RDMA) over converged Ethernet (RoCE) traffic flow rate;
the network congestion control is compatible with High Precision Congestion Control (HPCC); and
the network resource consumption-related data that is to be generated by the integrated circuit and/or the updated network resource consumption-related data are associated, at least in part, with Internet Engineering Task Force (IETF) Inband Flow Analyzer (IFA) telemetry information.

26. The network switch of claim 25, wherein:
the integrated circuit is comprised in an application specific integrated circuit;
the programmable packet processing pipeline circuitry comprises a data plane; and
the programmable packet processing pipeline circuitry and the data plane are programmable using Network Programming Language (NPL).

27. The network switch of claim 25, wherein:
the integrated circuit is to generate the updated network resource consumption-related data; and
the at least one switch system is to provide the updated network resource consumption-related data to the at least one other server system.

28. The network switch of claim 22, wherein:
the network switch is to be comprised in one of the multiple server systems.

29. A data center system comprising:
a network comprising multiple server systems and multiple network switch systems, the multiple server systems comprising at least one server system and at least one other server system, the multiple network switch systems comprising at least one network switch system and at least one other network switch system, the at least one network switch system comprising a network switch, the network switch comprising:
multiple ports communicatively coupled to the network; and
an integrated circuit for use in association with ternary content-addressable memory (TCAM), the integrated circuit being communicatively coupled to the multiple ports, the integrated circuit comprising:
programmable packet processing pipeline circuitry configurable to implement multiple programmable pipelines, the multiple programmable pipelines to perform match-action operations based upon received packet data and table data, the table data to be stored, at least in part, in the TCAM to identify packet processing rule data and/or next hops;
wherein:
the integrated circuit is to generate, in response, at least in part, to request packet data, network resource consumption-related data for use in generating packet flow transmit-rate information for at least one packet flow transmitted from the at least one server system in the network;
the request packet data is to be identified by the integrated circuit as requesting the network resource consumption-related data, based, at least in part, upon header data of the request packet data;
the packet flow transmit-rate information is to be used by the at least one server system to adjust flow-rate of the at least one packet flow from the at least one server system in the network;
the network resource consumption-related data is to be updated, based upon additional network resource consumption-related data from the at least one other network switch system, to generate updated network resource consumption-related data;
the updated network resource consumption-related data is (1) to be provided to the at least one other server system and (2) for use in generating the packet flow transmit-rate information by the at least one other server system;
the updated network resource consumption-related data comprises:
switch queue depth information associated with the at least one network switch system and/or the at least one other network switch system;
switch transit delay-related information associated with the at least one network switch system and/or the at least one other network switch system; and
switch identification information associated with the at least one network switch system and/or the at least one other network switch system;
the updated network resource consumption-related data is to be provided, via acknowledge (ACK) packet data, to the at least one server system from the at least one other server system; and
the flow-rate of the at least one packet flow from the at least one server system in the network is to be adjusted, based upon the packet flow transmit-rate information, in association with implementing network congestion control associated with the at least one packet flow.

30. The data center system of claim 29, wherein:
the at least one packet flow is to be identified based upon protocol tuple information; and
the protocol tuple information comprises packet header information.

31. The data center system of claim 30, wherein:
at least one other portion of the table data comprises exact match table data.

32. The data center system of claim 31, wherein:
the flow-rate of the at least one packet flow from the at least one server system in the network comprises a remote direct memory access (RDMA) over converged Ethernet (RoCE) traffic flow rate;
the network congestion control is compatible with High Precision Congestion Control (HPCC); and
the network resource consumption-related data that is to be generated by the integrated circuit and/or the updated network resource consumption-related data are associated, at least in part, with Internet Engineering Task Force (IETF) Inband Flow Analyzer (IFA) telemetry information.

33. The data center system of claim 32, wherein:
the integrated circuit is comprised in an application specific integrated circuit;
the programmable packet processing pipeline circuitry comprises a data plane; and
the programmable packet processing pipeline circuitry and the data plane are programmable using Network Programming Language (NPL).

34. The data center system of claim 32, wherein:
the integrated circuit is to generate the updated network resource consumption-related data; and
the at least one switch system is to provide the updated network resource consumption-related data to the at least one other server system.

35. The data center system of claim 29, wherein:
the network switch is to be comprised in one of the multiple server systems.
